(19) United States
(12) Patent Application Publication
(10) Pub. No.: US 2006/0277588 A1
(43) Pub. Date: Dec. 7, 2006

(54) Method for making a Web-DVD

(75) Inventors: John M. Harrington, Alexandria, VA (US); Alessandro Santarelli, Alexandria, VA (US); Jeffrey M. Baldwin, Fairfax, VA (US)

Correspondence Address: Breiner & Breiner, L.L.C., P.O. Box 19290, Alexandria, VA, 22320-0290, US

(73) Assignee: Madison Software Inc., Alexandria, VA (US)

(21) Appl. No.: 11/141,011

(22) Filed: Jun. 1, 2005

(51) Int. Cl. H04B 1/20

(52) U.S. Cl. 725/135

(57) ABSTRACT

A method of making a Web-DVD which integrates computer-based content, such as Web links/HTML content or images, with DVD-Video content by using a graphical user interface (GUI) is disclosed. The method provides a software application that allows a developer to add highly integrated computer-based content, such as, but not limited to, HTML content such as Web site links and images, PDF files and/or Power Point files, to a predetermined DVD-Video content with the developer using the GUI to create a Web-DVD instead of using complex JavaScript or HTML commands or programming language. The software application writes a series of DVD-ROM files, based on the developer's selection, e.g., “point and click,” of the GUI options, that create an interaction between the DVD-Video content and the computer-based content or HTML content.

### FIELD OF INVENTION

The present invention relates to a method of making a Web-DVD. More particularly, the invention relates to a method of making a Web-DVD which integrates computer-based content, such as Web links/HTML content or images, into a DVD-Video by using a graphical user interface.

### BACKGROUND OF INVENTION

Computer related technology and multimedia technology have become increasingly popular over the last several decades. Multimedia technology is the use of computers to present text, graphics, video, animation and/or sound in an integrated manner and provide for a display thereof. Multimedia technology is becoming commonplace since nearly all computers are capable of displaying video and audio outputs. Multimedia technology uses various storage devices such as video tapes, CD-ROMs, DVDs, laser disks and optical disks to store the audio-visual displays.

DVDs (digital video or versatile disks) are a popular format for recording multimedia events due to their versatility and ability to record a very large amount of data and display that data in a high quality format. Accordingly, many people use DVDs for storing and transmitting material such as entertainment material, instructional material, educational material and/or the like.

Computer-based content data such as Web site links from the Internet may be combined with DVD-Video content data and recorded on a DVD. However, a person who develops a DVD having computer-based content data and DVD-Video content data must know complex computer command languages such as JavaScript or HTML (HyperText Markup Language) programming languages in order to make the DVD. This creates a problem since many computer savvy people who may desire to create a DVD with DVD-Video content and computer-based content thereon do not know these complex computer command languages, such as JavaScript and HTML programming. Accordingly, a need exists for a method which enables a person to make a DVD having computer-based content data and DVD-Video content data, without the need for the person to know complex computer command languages such as JavaScript or HTML programming.

The prior art discloses various devices and methods for making a DVD. One such device/method is the Interactual® Player 2.0, manufactured by Sonic Solutions, which is a software application that combines the functionality of a Web Browser with the functionality of a DVD player. Interactual® Player 2.0 must be installed on an end user's computer in order to access a Web-DVD functionality. Interactual® Player 2.0 allows for bi-directional interaction between DVD-Video and HTML-based content. However, a Web-DVD developer using the Interactual® Player 2.0 must be proficient in HTML and JavaScript programming and Interactual® object model in order to create a Web-DVD.

Another such device/method is the eDVD® 3, manufactured by Sonic Solutions, which creates DVD-ROM elements that comprise an Interactual® Player 2.0-compatible Web-DVD, without requiring the Web-DVD developer to be proficient in HTML and JavaScript programming. However, eDVD® 3 only provides one-way communication between the DVD-Video and the HTML-based content by allowing the DVD-Video content to launch read-only memory (ROM) content and does not provide the ability for HTML-based content to control the playback of the DVD-Video content.

Another such device/method is the Macromedia® Director 2004, manufactured by Macromedia, Inc., which is a multimedia suite that builds rich content and applications for CDs, DVDs, kiosks, and the Internet and has the ability to embed DVD-playback within a Shockwave® 10 file. A Shockwave® 10 file plays in a Web browser when a Shockwave® Player is installed on the viewer's computer. The Shockwave® Player allows viewers to view interactive Web content like games, business presentations, entertainment, and advertisements from their Web browser.

Another such device/method is the DVD Studio Pro®, manufactured by Apple Computer, Inc., which is a software application which enables a user to embed Web links and links to local files through a proprietary technology called DVD@ccess. DVD@ccess commands are text strings that are embedded into unused portions of a DVD-Video stream which allow a developer to integrate Web links during the authoring process. However, these commands are not compliant with a DVD specification and are only recognized by an Apple DVD player since other players ignore these embedded Web links. However, as a separate option, a DVD@ccess applet is available for installation on a Windows® operating system.

Also known are Lamkin et al., U.S. Patent Application Publication No. 2002/0088011 A1 and U.S. Patent Application Publication No. 2002/0078144 A1, which disclose a method said to provide enhanced content for play across multiple play platforms by delivering media content and HTML content to a client device by using a computer command language.

Also known is Kelly et al., U.S. Patent Application Publication No. 2004/0044741 A1, which discloses a method, system and computer code for processing a cookie relating to a Web DVD system that includes a DVD device on which a DVD disk is running. The DVD device is linked by a communication link to a Web site targeted by the DVD disk, wherein the cookie has been generated by the Web DVD system as specified by a cookie-generation command received from a Web site. The Web DVD system adds to the cookie a DVD extension string that includes content associated with the DVD disk.

Also known is Chou et al., U.S. Patent Application Publication No. 2004/0210896 A1, which discloses an interactive media such as a DVD which can be created in more than one location. The editing of the content into chapters and the creation of menus that can access the content can be created at one location and information regarding the menus and the chapters can be transmitted to a second location and the DVD or other media can be recorded at the first or second location.

Also known is Vella et al., U.S. Patent Application Publication No. 2004/0098754 A1, which discloses a method said to enhance the viewing of static or previously recorded audio visual productions by linking a message system to the viewing process to allow viewers to post messages and replies to those messages on threaded “bulletin boards” relating to each audio visual production with each message linked to the audio and/or video media timeline.

Also known is Green, U.S. Patent Application Publication No. 2005/0022232 A1, which discloses a method and apparatus for creating and/or reproducing an audio/visual product, by which a user's access to the audio/visual product is restricted. The method for use in creating an audio/visual product includes receiving original audio/visual data intended for playback according to an original content sequence; dividing the original audio/visual data into a plurality of cells; creating a plurality of sequence instructions each representing a playback sequence for playing back the cells in a specified order; allocating the plurality of sequence instructions each to one of a plurality of structural locations within the audio/visual product; and producing a destination function operable, based on an access code, to calculate a destination structural location amongst the plurality of structural locations and thereby select one amongst the plurality of sequence instructions.

Also known is Powell, U.S. Patent Application Publication No. 2005/0022125 A1, which discloses a method and tool for the creation of content for home video that is said to be easy enough to be used by a person with no prior video creation experience which allows the user to take advantage of continuing innovations in consumer video technology.

Also known is Fujiwara, U.S. Patent Application Publication No. 2004/0216169 A1, which discloses an optical disk reproducing apparatus which obtains external subtitle information to display at the time of reproduction of video information recorded on an optical disk such as a DVD.

Also known is Numata, U.S. Patent Application Publication No. 2004/0133926 A1, which discloses an additional information inserting apparatus automatically generating additional information to be added to an audio video signal, to be recorded or transmitted, on the basis of original additional information inserted in an original audio video signal.

Also known are Brodersen et al., U.S. Patent Application Publication No. 2003/0005442 A1 and U.S. Pat. No. 6,453,459, which disclose a data processing system-based authoring system and method that is said to essentially remove an author from consideration of the structures and low-level instruction sets of a DVD specification.

The devices and methods above have various shortcomings including not providing integration of HTML-based content with DVD-Video content, requiring a person making a Web-DVD to be proficient in complex computer command programming languages and only providing unilateral communication between the DVD-Video content and the HTML-based content. These and other shortcomings of these devices and methods are addressed by the present invention.

### OBJECTS AND SUMMARY OF INVENTION

The present invention relates to a method of making a Web-DVD. More particularly, the invention relates to a method of making a Web-DVD which integrates computer-based content, such as Web links/HTML content or images, with DVD-Video content by using a graphical user interface (GUI).

The method of making a Web-DVD of the invention provides a software application that allows a developer, i.e., a person making a Web-DVD, to add highly integrated computer-based content, such as, but not limited to, HTML content such as Web site links and images, PDF (portable document format) files and/or Power Point files, to a predetermined DVD-Video content with the developer using a GUI to create a Web-DVD instead of using JavaScript or HTML commands or programming language. The software application writes a series of DVD-ROM files, based on the developer's selection, e.g., “point and click,” of the GUI options that create an interaction between the DVD-Video content and the computer-based content or HTML content.

Each GUI option provided by the software application transmits a predetermined command(s), such as a JavaScript and/or HTML command(s), which is a suitable command to the computer to produce a desired result in the creation of a Web-DVD. The developer of a Web-DVD does not need to be proficient in complex computer command languages such as JavaScript and HTML programming since the appropriate command is predetermined and associated with each GUI option provided by the software application. The developer clicks a desired GUI option, such as an icon or item on a menu or toolbar, and the software application of the invention provides an appropriate command to the computer in order to obtain the desired result or function in creating a Web-DVD.

In creating a Web-DVD, the invention uses the multimedia components built into a computer's operating system so that an end user of the Web-DVD does not have to install a proprietary player in order to access the functionality of the Web-DVD. Generally, an operating system is interacted with through a set of computer language commands. However, the GUI options of the present invention allow a developer to create a Web-DVD by entering commands by pointing and clicking GUI options, such as icons and toolbars with drop-down menus, that appear on the screen instead of having to enter complex computer language commands. The software application of the invention then generates and transmits the predetermined computer language commands to perform the desired function. Once a developer of a Web-DVD has made the desired selections to create the desired functions by using the GUI options, the selected DVD-Video content and computer-based content is blended together to create a Web-DVD. The method of making a Web-DVD according to the present invention is described in greater detailed hereafter.

A primary object of the invention is to provide a method of making a Web-DVD which integrates computer-based content, such as Web links/HTML content or images, PDF files and/or Power Point files, with DVD-Video content by using a graphical user interface.

Another primary object of the invention is to provide a method of making a Web-DVD which enables a developer to add highly integrated computer-based content, such as Web site links and images, PDF files and/or Power Point files, to a predetermined DVD-Video content without entering complex computer command languages such as HTML or JavaScript commands.

Another primary object of the invention is to provide a method of making a Web-DVD which provides bi-directional communication between the DVD-Video content and the computer-based/HTML-based content such that the computer-based/HTML-based content can launch and/or control the playback of the DVD-Video content and the DVD-Video content can launch and/or control the playback of the computer-based/HTML-based content in a Web-DVD.

Another object of the invention is to provide a method of making a Web-DVD wherein the Web-DVD uses the multimedia components built into a computer's operating system so that an end user does not have to install a proprietary player in order to access and view the Web-DVD.

Another object of the invention is to provide a method of making a Web-DVD that is simple, easy to use and inexpensive.

These primary and other objects of the invention will be apparent from the following description of the preferred embodiments of the invention and from the accompanying drawings.

### BRIEF DESCRIPTION OF THE DRAWINGS

Referring to the drawings:

FIG. 1 shows a schematic diagram of a system of integrating components of a Web-DVD made according to the present invention.

FIG. 2 shows a schematic diagram of an embodiment of a system for making a Web-DVD according to the present invention.

FIG. 3 shows a first embodiment of an initial start window of the present invention.

FIG. 4 shows a second embodiment of an initial start window of the present invention.

FIG. 5 shows a first embodiment of a Web-DVD Application Window of the present invention displaying an embodiment of a Project Layout Editor window.

FIG. 6 shows a second embodiment of a Web-DVD Application Window of the present invention displaying an embodiment of a Project Layout Editor window.

FIG. 7 shows a first embodiment of a Web-DVD Application Window of the present invention displaying an embodiment of a DVD Behaviors Editor window.

FIG. 8 shows a second embodiment of a Web-DVD Application Window of the present invention displaying an embodiment of a DVD Behaviors Editor window.

FIG. 9 shows a first embodiment of a Web-DVD Application Window of the present invention displaying an embodiment of a HTML Behaviors Editor window.

FIG. 10 shows a second embodiment of a Web-DVD Application Window of the present invention displaying an embodiment of a HTML Behaviors Editor window.

FIG. 11 shows a first embodiment of a Page Properties tab window of the HTML Behaviors Editor window of FIG. 9.

FIG. 12 shows a second embodiment of a Page Properties tab window of the HTML Behaviors Editor window of FIG. 9.

FIG. 13 shows an embodiment of the files which may be created and written in making a Web-DVD according to the present invention.

### DETAILED DESCRIPTION OF THE PREFERRED EMBODIMENTS

The invention relates to a method of making a Web-DVD which integrates computer-based content, such as Web links/HTML content or images, with DVD-Video content by using a GUI. The method of the invention for making a Web-DVD provides a software application that allows a developer to add highly integrated computer-based content, such as, but not limited to, HTML content such as Web site links and images, PDF files and/or Power Point files, to a predetermined DVD-Video content with the developer using a GUI to create a Web-DVD instead of using complex JavaScript or HTML commands or programming language. The software application writes a series of DVD-ROM files, based on the developer's selection, e.g., “point and click,” of the GUI options, that create an interaction between the DVD-Video content and the computer-based content or HTML content.

Each GUI option provided by the software application transmits a predetermined command(s), such as a JavaScript and/or HTML command(s), which is a suitable command to the computer to produce a desired result in the creation of a Web-DVD. The developer of a Web-DVD does not need to be proficient in complex computer command languages such as JavaScript and HTML command programming since the appropriate command is predetermined and associated with each GUI option provided by the software application of the invention. The developer clicks a desired GUI option, such as an icon or item on a menu or toolbar, and the software application provides an appropriate command to the computer in order to obtain the desired result or function in creating a Web-DVD as detailed hereafter.

In creating a Web-DVD, the invention uses the multimedia components built into a computer's operating system so that the end user of the Web-DVD does not have to install a proprietary player in order to access the functionality of the Web-DVD. An operating system is a program on every computer which, among other things, runs all other programs, recognizes input from a keyboard or mouse, sends output to a display screen, monitors files and directories, controls peripheral devices such as disk drives and printers, ensures that different programs and multiple users on a large system do not interfere with each other, and ensures unauthorized users do not access the system. Operating systems include, but are not limited to, Windows®, DOS, UNIX®, OS/2, Linux®, and MacOS. Generally, an operating system is interacted with through a set of computer language commands. However, the GUI options of the present invention allow a user to enter commands by pointing and clicking GUI options, such as icons and toolbars with drop-down menus, that appear on the screen instead of having to enter complex computer language commands.

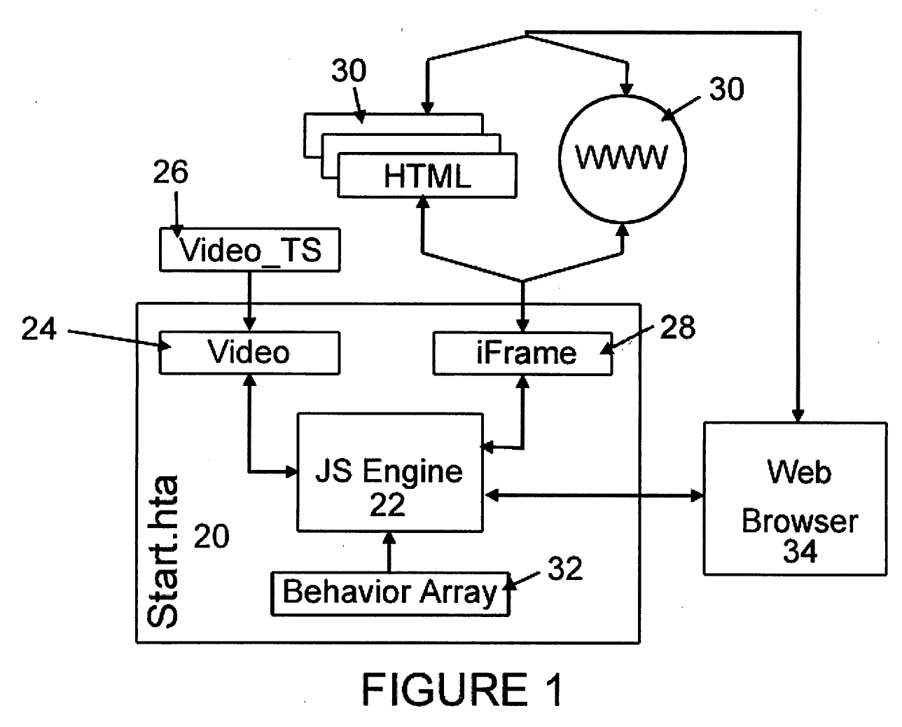

Upon viewing a completed Web-DVD, the software application automatically runs a master page 20, preferably called “start.hta,” as shown for example in FIG. 1 and as detailed hereafter.

Referring to FIGS. 1-13, in a preferred embodiment, the DVD-Video content used to make a Web-DVD according to the invention is created prior to commencing the method of the invention in any suitable manner. The DVD-Video content is then compiled in a VIDEO_TS folder 26 or directory which contains the multiplexed (muxed) video and audio files, as well as the menu programming which is playable by set-top DVD players and computer DVD players. Then, the software application of the invention is installed and/or run on the computer.

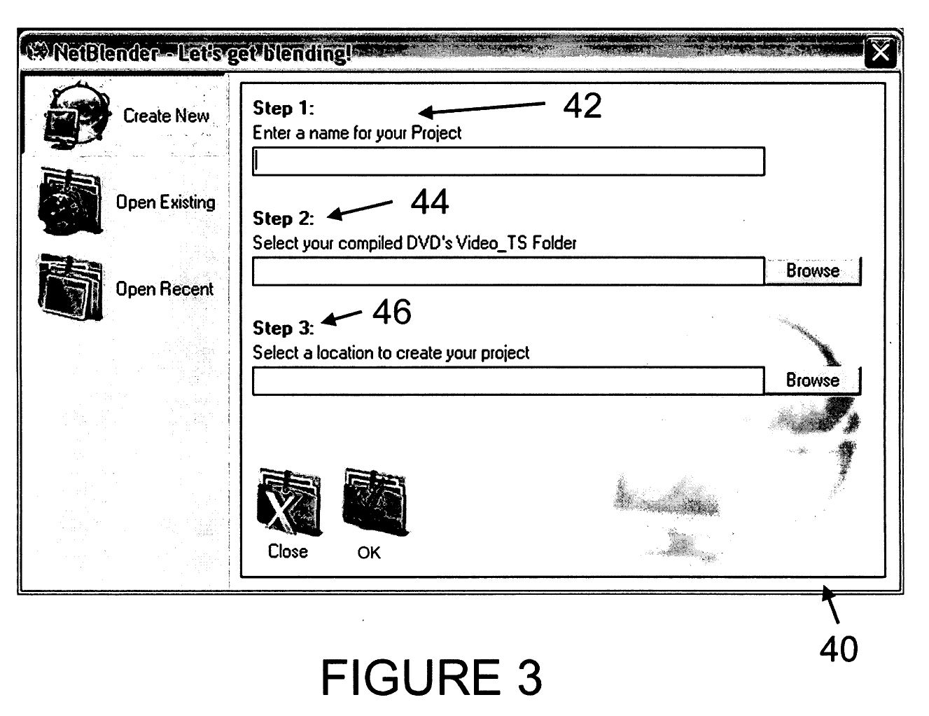

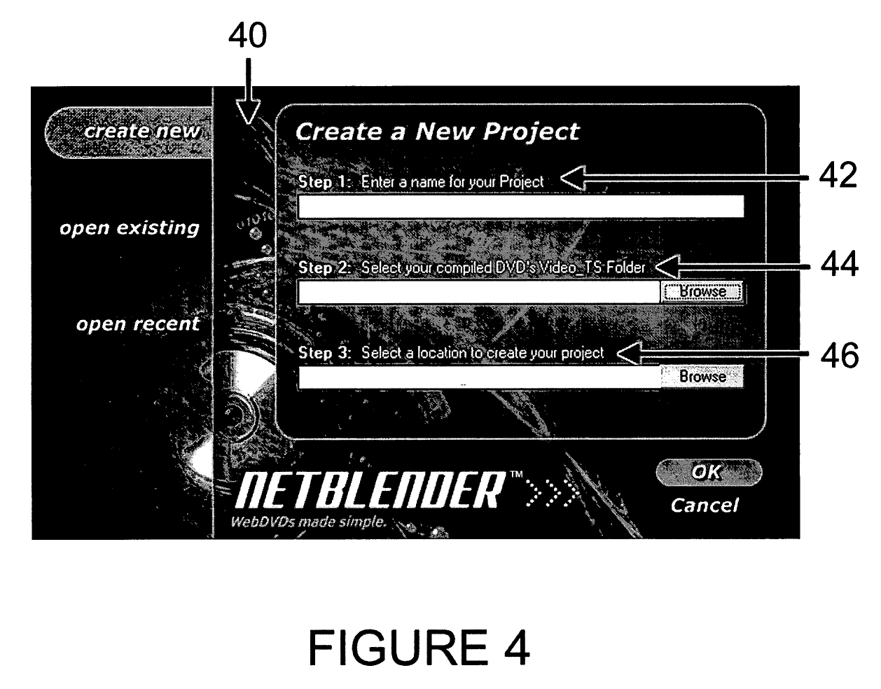

Once the software application is installed and/or run on the computer, the software application launches an initial start window 40 wherein a developer may create a new Web-DVD project, open an existing Web-DVD project or open a recent Web-DVD project as shown, for example, in FIGS. 3 and 4. However, the software application may launch any suitable initial start window. Creating a new Web-DVD project is detailed hereafter. Opening an existing Web-DVD project and opening a recent Web-DVD project allows a developer to modify, edit or add to an already existing Web-DVD project in a similar manner as in creating a new Web-DVD project.

In creating a new Web-DVD project, the software application preferably prompts a developer to perform three initial steps: (1) enter a project name 42, (2) select a compiled DVD Video_TS folder 44, and (3) select a location to create a project 46. However, any suitable type of initial steps may be prompted by the initial start window 40. Preferably, selecting a compiled DVD Video_TS folder 44 enables a developer to access a pre-authored compiled DVD for use in making a Web-DVD in accordance with the invention. Selecting a location to create a project 46 preferably enables a developer to select a location where the software application will place/store any ROM files that are created. In a preferred embodiment, the software application may select the following directory by default:

My Documents/WebDVD Projects/projectname/. Eventually, the created ROM files may be placed in the same directory where the VIDEO_TS folder is located upon compiling the final ROM files. However, the ROM files may be stored in any suitable folder or directory. The developer may close the initial start window 40 at any point to terminate the project or upon completion of selecting the appropriate directories, by clicking “OK”.

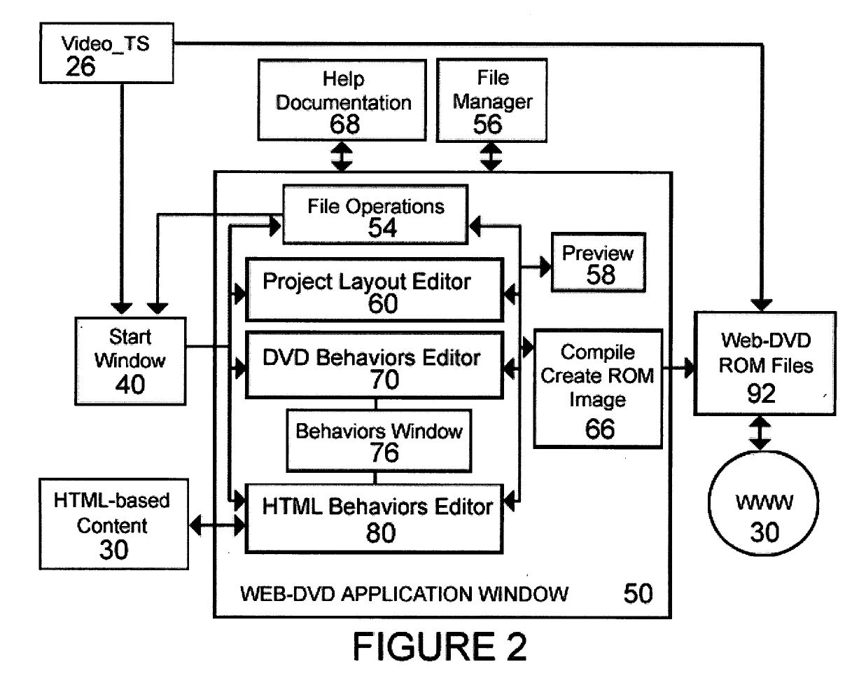

Once the initial steps are completed, the software application automatically opens a developer application. For example, when the operating system is Microsoft® Windows®, the software application automatically opens a developer application which is a main page in which a developer creates a Web-DVD, as shown for example in FIG. 2.

In a preferred embodiment, the developer application is preferably displayed as a Web-DVD Application Window 50. However, the developer application may be any suitable developer application with any suitable title and any suitable arrangement. The developer may then set the size and various attributes of the video object and set the size and various attributes of the computer-based content in a layout editing page, which is preferably a Project Layout Editor as detailed hereafter.

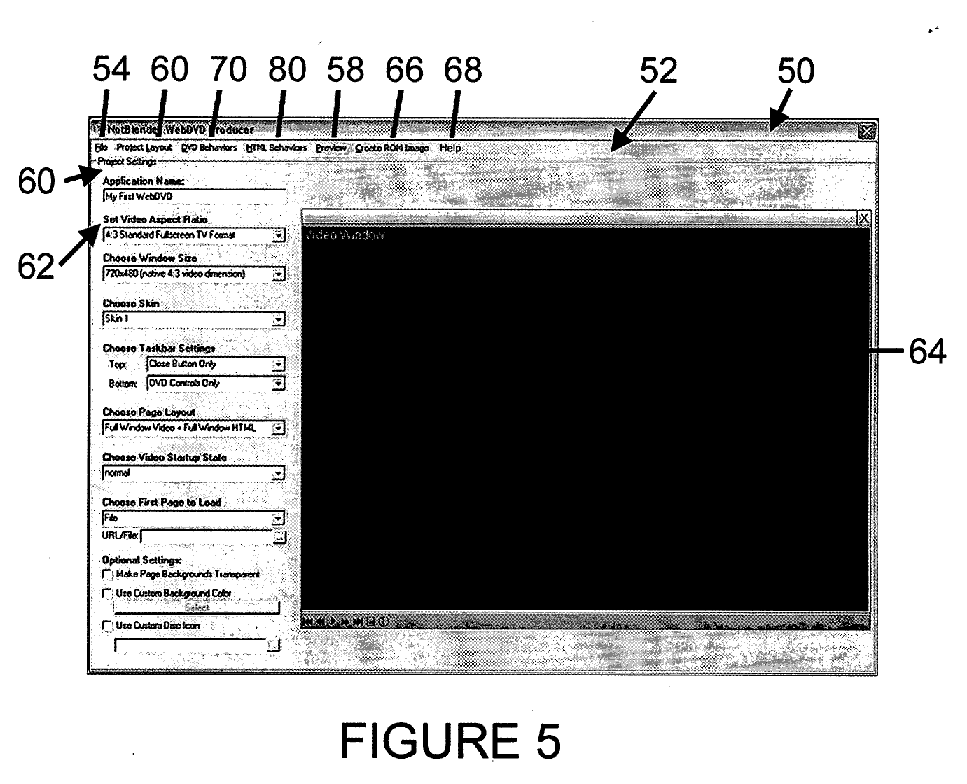

FIG. 2 shows a schematic diagram of the Web-DVD Application Window 50 in conjunction with the DVD-Video content in the Video_TS file 26, the computer-based content 30, such as HTML-based content and World Wide Web (WWW) content, and the initial start window 40. The software application preferably displays the Web-DVD Application Window 50 and elements thereof as a GUI screen and options, as shown for example in FIGS. 5-10. While the preferred GUI options on the Web-DVD Application Window 50 are detailed hereafter, any suitable number, type and arrangement of GUI options may be provided and be within the scope of the invention. The graphical nature of the GUI of the Web-DVD Application Window 50 allows a developer to create a Web-DVD without being proficient in complex computer command languages such as JavaScript and HTML. Based on the developer's selections within the GUI, the software application writes a series of DVD-ROM files 92 that create an interaction between the DVD-Video content contained in the VIDEO_TS folder 26 and the computer based content 30 such as, but not limited to, HTML-based content and files found on the World Wide Web.

A preferred Web-DVD Application Window 50 preferably has the following GUI options: File or File Operations 54; Project Layout or Project Layout Editor 60; DVD Behaviors or DVD Behaviors Editor 70 which utilizes a Behaviors Window 76; HTML Behaviors or HTML Behaviors Editor 80 which utilizes a Behaviors Window 76; File Manager 56; Preview 58; Create ROM Image or Compile 66, and Help or Help Documentation 68, in a toolbar 52. The File or File Operations 54 option preferably provides the following fields: Open, New; Save; Save As, and Exit. The fields represent functions as generally known in the art.

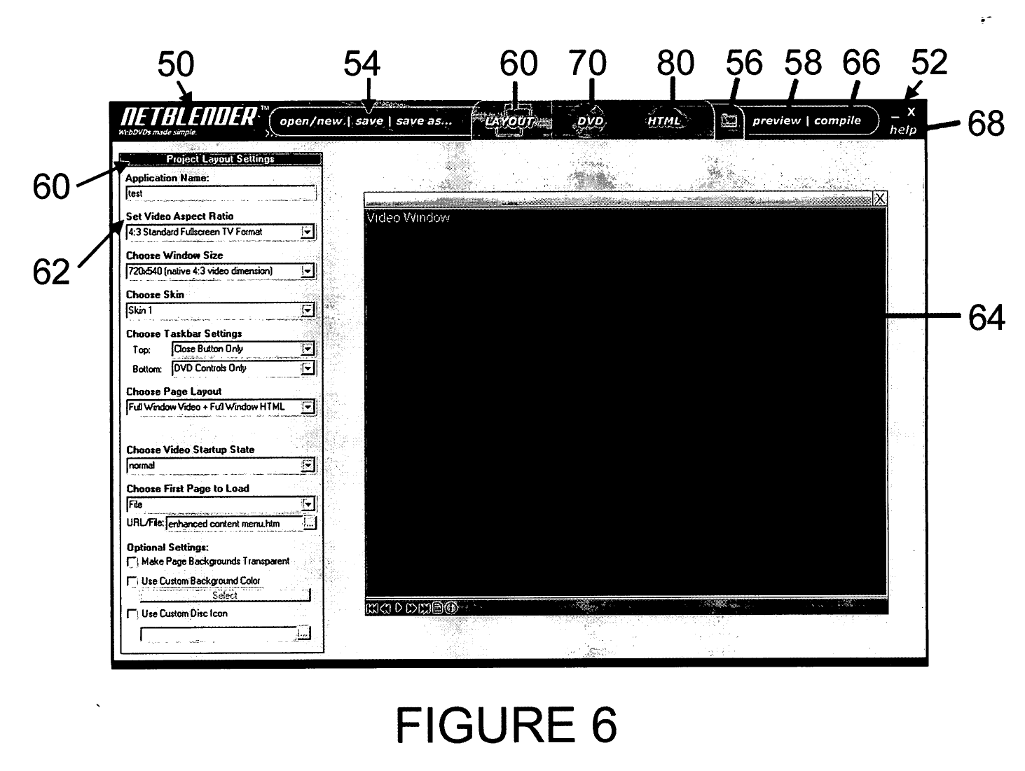

The Project Layout option is a layout editing page, preferably a Project Layout Editor 60, as shown for example in FIGS. 5 and 6, which enables a developer to set the size, layout and display attributes for the Web-DVD by selecting from a plurality of fields 62 which may be in the form of drop-down menu lists. The Project Layout Editor 60 also comprises a large windowed area 64 on the screen which graphically displays the layout choices that are selected in the plurality of fields. In a preferred embodiment, the plurality of fields 62 may comprise: Application Name; Set Video Aspect Ratio; Choose Window Size; Choose Skin; Choose TaskBar Settings; Choose Page Layout; Choose Video Startup State; Choose First Page to Load, and Optional Settings.

The Application Name field allows a developer to provide or modify the name of the project. Additionally, the name in the Application Name field may appear in a title bar of the Web-DVD if desired. Changing the text in the Application Name field will not change the project file name that was previously saved in My Documents/WebDVD Projects/projectname.

The Set Video Aspect Ratio field enables a developer to choose the correct aspect ratio of the video from a drop-down menu list preferably including, but not limited to, 4:3 Standard Fullscreen TV Format and 16:9 Standard Widescreen TV Format.

The Choose Window Size field enables a developer to choose the screen size of the Web-DVD including, but not limited to, 720×480 (native 4:3 video dimension); 864×480 (native 16:9 video dimension); 800×600; 1024×768, and fullscreen. The size selection may depend upon the intended use of the Web-DVD project. For example, if the project is going to rely primarily on DVD menus for navigation and playback of video, with web-content opening in new windows, then the developer would likely choose to make the window size the same as the native video resolution (720×480 or 864×480, depending on the aspect ratio). If the developer is creating custom HTML content that will control the video and desires the Web-DVD to look more like a Web page, the developer may choose a standard Web page screen size such as 800×600 or 1024×768. Choosing “fullscreen” will cause the Web-DVD project to maximize, regardless of an end user's screen settings. This option is useful for full-screen DVD playback.

The Choose Skin field enables a developer to choose color schemes that affect the overall appearance of the Web-DVD including, but not limited to, Skin 1; Skin 2; Skin 3, and Skin 4. The color schemes of the skins may be predetermined or custom selected. The skins are Cascading Style Sheets (CSS), a feature in HTML that defines how different elements such as, but not limited to, headers and links, appear. These style sheets can then be applied to any HTML page. The term cascading derives from the fact that multiple style sheets can be applied to the same HTML page.

The Choose TaskBar Settings field enables a developer to affect the appearance of the top and bottom taskbars on the Web-DVD. The field settings for the top taskbar preferably include: None; DVD Controls+Close Button; DVD Controls Only; Close Button Only; and Close Button+Application Name. The field settings for the bottom taskbar preferably include: None; DVD Controls+Close Button; DVD Controls Only; and Close Button Only.

The Choose Page Layout field enables a developer to determine the size and relative placement of the video window and the HTML Pane within the main Web-DVD Application Window. As the selection changes in the drop-down menu list, a new corresponding layout appears in the windowed area 64 on the screen. The Choose Page Layout field preferably includes: No Video+Full Window HTML; Full Window Video+Full Window HTML; Windowed Video Left+Full Window HTML; Windowed Video Right+Full Window HTML; Windowed Video Left+Full Window HTML Right; and Windowed Video Right+Full Window HTML Left. These options perform the function as named.

The Choose Video Startup State field enables a developer to determine how the DVD-Video will appear when the Web-DVD project is completed and launched by an end user including: Normal; Full Window, and Hidden. By selecting Normal, the DVD-Video will play in the window size selected in the Choose Page Layout field. By selecting Full Window, the DVD-Video will play in the entire window size (as determined by the selection in the Choose Window Size field) regardless of the layout chosen. This type of layout may be desirable for an introductory video or attract loop and then have the video shrink to its normal windowed position later in the project. By selecting Hidden, the DVD-Video does not appear when the Web-DVD is initially launched. This type of layout may be desirable when the project is driven by the computer-based/HTML content at the outset and then the developer desires to make the DVD-Video appear later in the project.

The Choose First Page to Load field enables a developer to determine what content will load into the HTML Pane when the Web-DVD is launched. These field options preferably include: Blank Page, File and URL. By selecting Blank Page, nothing is loaded upon startup. By selecting File, a local HTML or text file is loaded upon startup as the first page. By selecting URL, a remote file will be prompted and the developer will enter the file's location (URL). This file will then be the first file loaded upon startup.

The Optional Settings field preferably include: Make Page Background Transparent, Use a Custom Background Color and Use Custom Disc Icon. By selecting Make Page Background Transparent, the backgrounds of the pages in the HTML windows are transparent. This option may preferably be selected where the developer desires the background color of the main Web-DVD window to show through the HTML window. By selecting Use a Custom Background Color, the developer may choose a color for a page background and override the skin's background color. By selecting Use Custom Disc Icon, the developer may preferably select an icon that will be the disc icon that the end user sees in the “My Computer” display when viewing the completed Web-DVD project.

The DVD Behaviors option on the Web-DVD Application Window 50 preferably provides and displays a DVD Behaviors Editor 70 which enables a developer to assign “behaviors” to chapter points in the Web-DVD, thereby creating “trigger events.” Trigger events are events or points in the Web-DVD which initiates the happening or action of another event when the initial event occurs. Trigger events may initiate an action such as opening or closing a HTML page that initiates an action when another event occurs. The DVD Behaviors Editor 70 also enables a developer to create other points where behaviors may be assigned such as custom markers and clips in the DVD-Video where no pre-authored chapter points exist to which behaviors can be assigned.

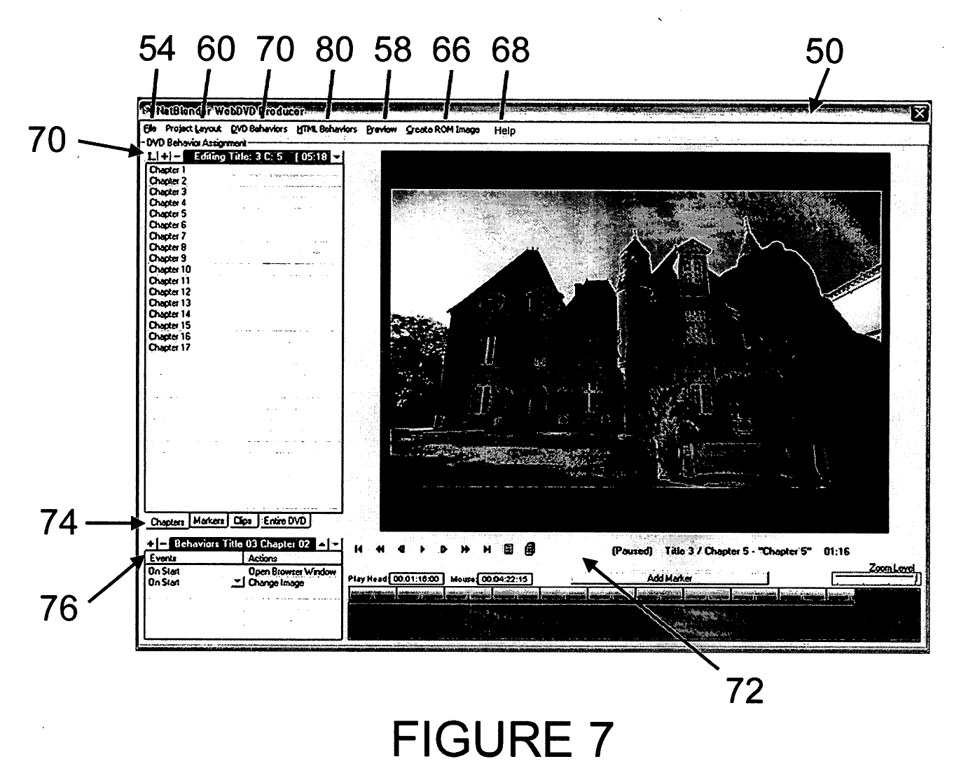

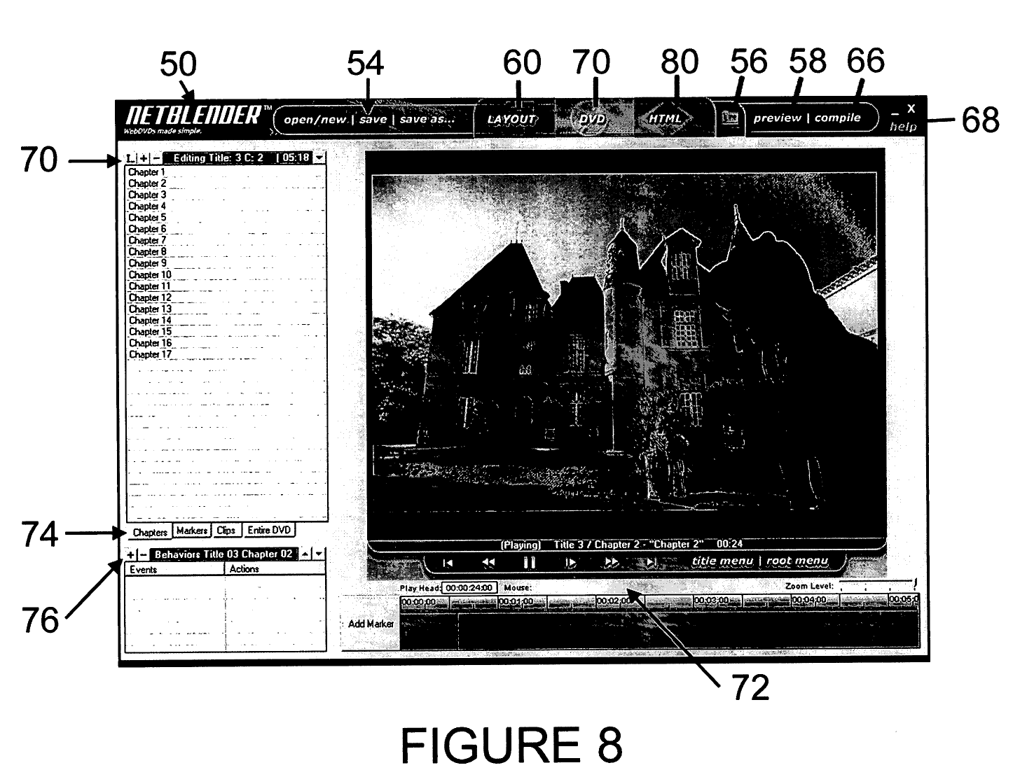

A preferred embodiment of a GUI screen of a DVD Behaviors Editor 70 is shown for example in FIGS. 7 and 8. However, any suitable field options and layout may be used for the DVD Behaviors Editor. The DVD Behaviors Editor 70 preferably comprises a Timeline and Playback Area 72, a Navigation Library 74 and a Behaviors Window 76. The Timeline and Playback Area 72 enables a developer to navigate the DVD-Video in order to select the appropriate chapter or time point to create trigger events. In order to create trigger events, a developer clicks a Play icon which begins the playback of the DVD-Video content which plays exactly as the DVD-Video content would in a normal DVD player. The developer may then utilize menu buttons and other navigation tools that has been authored into the DVD. A timeline will preferably be located below a Playback window of the Playback Area which enables a developer to scroll through the DVD-Video by clicking the curser at any location in the timeline. A zoom level selector may also be located near the timeline. The zoom level selector enables the developer to view the graphical representation of the DVD-Video being played in the timeline at the desired zoom level in order to facilitate the placement of Custom Markers as detailed hereafter.

Custom Markers may be created at any point in the timeline by placing the play head at a desired point in the timeline and clicking an Add Marker button to create a trigger event. A behavior may then be assigned to the marker as detailed hereafter.

A Navigation Library 74 preferably comprises various tabs and a display. Preferred tabs include: Chapters, Markers, Clips and Entire DVD. The display of the Navigation Library 74 shows the developer the current title of the DVD-Video that is being viewed and the total running time of the DVD-Video in the title. The Navigation Library 74 also shows the chapters in the title of the DVD-Video content.

In a preferred Navigation Library 74, the Chapters tab displays the DVD-Video's chapter layout of the title that is currently playing. As the developer navigates the DVD-Video, the display of chapters change every time titles jump/change. Any chapter may be renamed from the default name (e.g., Chapter 1, Chapter 2, etc.) to a name more meaningful in relation to the subject matter of the chapter. To rename a chapter, the developer clicks an Edit Label button, thereby highlighting the chapter name to be changed. The developer may then type the new name and, upon completion of the name change, click Enter or another part of the screen to affect the change.

The Markers tab displays a list of custom markers that the developer has created or may create. A marker is a point where an action/event may be initiated by assigning a behavior to the marker using the Behaviors Window 76. Two markers may be used to define the start and end points of a Clip as detailed hereafter. The developer may create a new marker at a predetermined play head location by clicking on an “add” icon button when the Marker tab is selected. In a preferred embodiment, an “add” icon is preferably a “+” icon button. In a similar manner, the developer may delete a marker at a predetermined location by clicking on a “delete” icon button. In a preferred embodiment, a “delete” icon is preferably a “−” icon button. By default, a marker's name is preferably based on the marker's location in time within the title (e.g., Marker at 00:03:20:00). The markers may be renamed using the Edit Label button in the same manner as described above.

In a preferred embodiment, a marker may signal the initiation of a HTML page, a Web page, a PDF file, a HTML behavior, a DVD behavior, and/or any other suitable action.

The Clips tab allows a developer to create custom clips defined as a duration between two markers. A custom clip is a specific duration of video on the DVD, that is independent from the DVD's chapter organization, that the developer may play directly from HTML pages. In a preferred embodiment, the start and/or end point of a custom clip may signal the initiation of an action/event that the developer assigns using the Behaviors Window 76. The developer may create a custom clip at a predetermined play head location between two markers by clicking on the “add” icon button when the Clips tab is selected. The software application of the invention preferably prompts the developer to select a start marker and an end marker where the custom clip is to be inserted. The “add” icon button is preferably a “+” icon button, as described above. In a similar manner, the developer may delete a custom clip at a predetermined location by clicking on the “delete” icon button. In the present invention, the “delete” icon button is preferably a “−” icon button, as described above. The clips may be renamed using the Edit Label button in the same manner as described above.

The Entire DVD tab preferably displays a listing of all of the chapters on the DVD.

A Behaviors Window 76 in the DVD Behaviors Editor 70 enables a developer to assign behaviors to the predetermined chapters, markers and clips. To assign a behavior, the developer selects the desired chapter, marker or clip in the Navigation Library 74 and then clicks an “add behavior” icon button in the Behaviors Window 76. The “add behavior” icon button is preferably a “+” icon button. In a similar manner, the developer may delete an assigned behavior by clicking a “delete behavior” icon button. The “delete behavior” icon button is preferably a “−” icon button.

The developer may create action stacks, i.e., multiple actions/events, by assigning multiple behaviors to any chapter or marker. The execution of the behaviors in an action stack may be reordered by using “reorder” icon buttons. In a preferred embodiment, the “reorder” icon buttons are up and down arrows in the Behaviors Window 76. A behavior may be reordered by clicking and highlighting a particular behavior and then clicking the appropriate “up” or “down” arrow until the selected behavior is reordered into a desired order. The behaviors listed in the Behaviors Window 76 will execute in the order in which they are arranged, i.e., from top to bottom.

When a behavior is assigned to a chapter or clip, the developer may set the behavior to execute at the beginning of a chapter or clip, i.e., “On Start,” or at the end of the chapter or clip, i.e., “On End.” With markers, a behavior may only be assigned at the beginning, i.e., “On Start,” since markers are located at a set time point, not a time range.

The following are preferred behaviors that may be assigned by the developer in making a Web-DVD. However, the software application may comprise any suitable behaviors to be assigned by the developer in making a Web-DVD. In a preferred embodiment, HTML behaviors/actions may be assigned to chapters, markers and clips in the DVD Behaviors Editor and DVD behaviors/actions may be assigned to elements in the HTML pages in an HTML Behaviors Editor. The functioning of the HTML Behaviors Editor will be further detailed hereafter.

Preferred HTML behaviors that may be assigned to chapters, markers and clips in the DVD Behaviors Editor include, but are not limited to, Open Browser Window; Load Page in HTML Pane; Set Element Visibility; Set Element Inner Text; Set Element Style; Set Element Classname; Change Image; Close Application, and Wait. The Open Browser Window behavior creates a pop-up browser window and loads a page which can be located at a remote uniform resource locator (ur1), (e.g., http://www.netblender.com) or a local page on the developer's computer. A Browse icon button may be used to locate and retrieve a local page. The Load Page in HTML Pane behavior loads a page into the HTML Window that resides within the main Web-DVD Application Window 50. The page may be located at a remote ur1 or a local page. A Browse icon button may be used to locate and retrieve a local page. The Set Element Visibility behavior allows a developer to turn on/off the visibility of any element in a HTML page that is loaded into the HTML Window. The developer must be able to identify the element by its “element ID” which can be set by the developer as detailed hereafter. The Set Element Inner Text behavior changes the text of an element in a HTML page that is loaded into the HTML Window. This behavior is beneficial for subtitling or dramatically changing text based on the playback of the DVD-Video. The Set Element Style behavior changes the style of an element in a HTML page. The Set Element Classname behavior sets the element's classname. The Change Image behavior changes an image on the page loaded into the HTML Window with a new image selected by the developer. The Close Application behavior closes the application. The Wait behavior allows a developer to specify an amount of time, such as in milliseconds, that creates a pause in an action stack. For example, because DVDs tend to cache the last image in memory while transitioning from a menu to a video clip, the Wait behavior can give the player time to make the transition before showing the video or changing a HTML page.

Preferred DVD behaviors that may be assigned include, but are not limited to, Play; Pause; Stop; Go to Next Chapter; Go to Previous Chapter; Fast Forward; Rewind; Play Title; Play Chapter; Play Clip; Go to Marker; Hide Video; Show Video Fullscreen; Show Video Windowed; Show Title Menu; Show Root Menu, and Wait. The Play; Pause; Stop; Go to Next Chapter; Go to Previous Chapter; Fast Forward, and Rewind behaviors perform the same function as named and generally known in the art. The Play Title behavior plays the DVD-Video within a title set, beginning with the first chapter. The Play Chapter behavior plays a chapter of a DVD-Video within a title set. The Play Clip behavior plays a clip that has been defined between two markers by the developer. The Go to Marker behavior plays the DVD-Video beginning at a marker that has been set by the developer. The Hide Video behavior hides the DVD-Video and pauses playback. For example, if HTML content resides behind a video object, as determined by the selected layout, the HTML content will become visible when the video object, e.g., DVD-Video content, hides. The Show Video Fullscreen behavior shows the DVD-Video full screen. The Show Video Windowed behavior shows the DVD-Video in the windowed size of the video object as determined by the selected layout. The Show Title Menu behavior performs a title menu call returning the DVD-Video to the title menu as determined by the authoring of the DVD-Video. The Show Root Menu behavior performs a root menu call returning the DVD-Video to the current root menu as determined in the authoring of the DVD-Video. All DVDs have a hierarchical menu organization with a title menu at the top, sometimes called the top menu. There is only one title menu on a DVD. Beneath the title menu are root menus, of which there can be 99 per video title set. The Wait behavior allows a developer to specify an amount of time, such as in milliseconds, that creates a pause in an action stack, as detailed above.

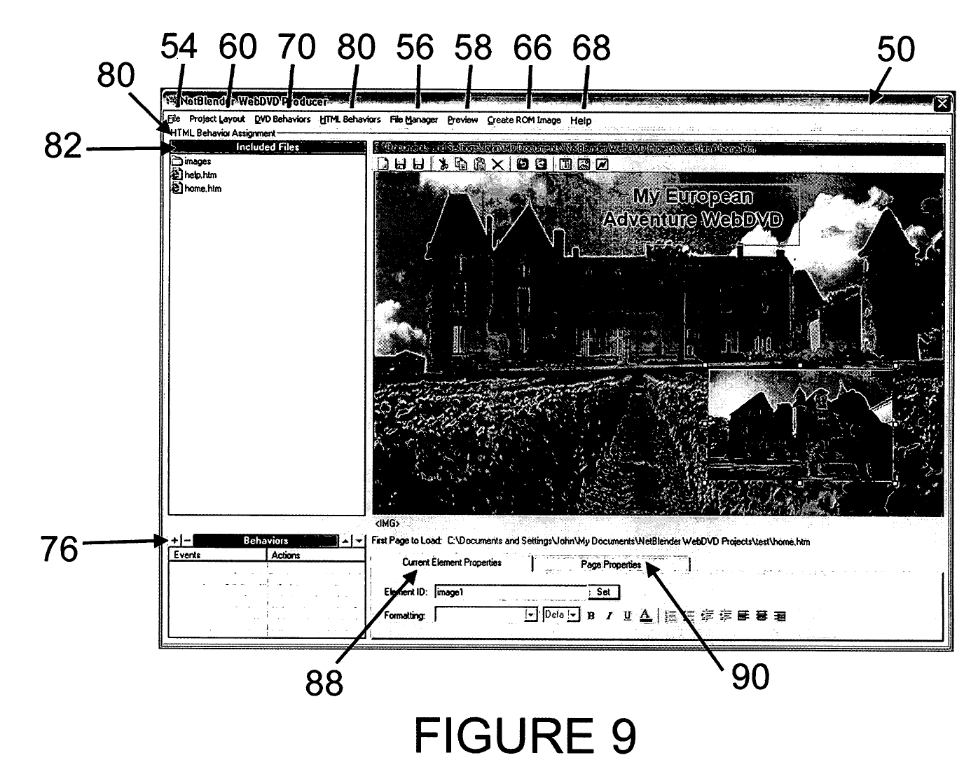

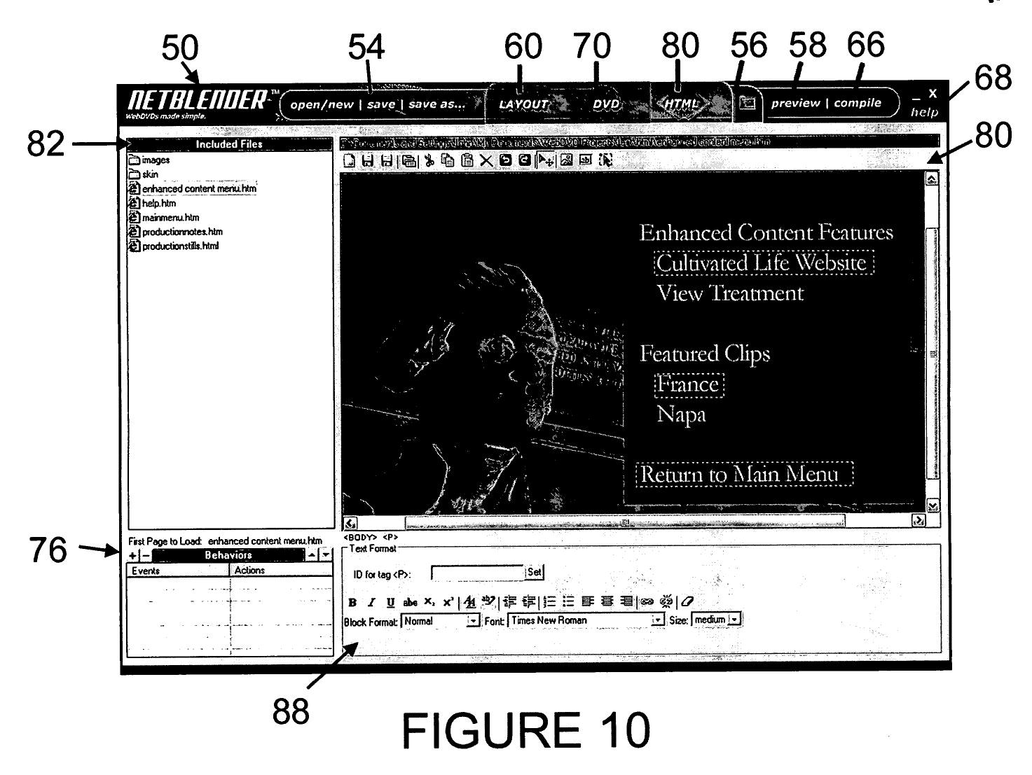

The HTML Behaviors option on the Web-DVD Application Window 50 provides a HTML Behaviors Editor which enables a developer to open HTML pages that have been created for inclusion in the Web-DVD. HTML pages may be created in any suitable manner. However, HTML pages may be created by using a built-in editor in the software application of the invention. In a preferred embodiment, the HTML Behaviors Editor 80 comprises an Included Files Library 82, a HTML Editor and a Behaviors Window 76, as shown for example in FIGS. 9 and 10.

The Included Files Library 82 is preferably a directory listing which shows the files and folders located in the HTML folder located in the project directory in the project folder. Any HTML content that a developer wants to include in the Web-DVD is moved into the Included Files Library 82 directory. The File Manager 56 option on the Web-DVD Application Window 50 enables a developer to move files into the HTML folder in the Included Files Library 82 directory without the having to leave the application, as detailed hereafter. Any page in the HTML folder may be viewed in the HTML Editor.

The HTML Editor enables a developer to (1) open existing HTML pages and add Web-DVD behaviors to the HTML pages, (2) create and edit new HTML pages for inclusion in the Web-DVD, and (3) a combination thereof.

The HTML Editor may enable a developer to open existing HTML pages and add Web-DVD behaviors to the HTML pages as follows. For example, if a HTML page that will be used in the Web-DVD is not in the Included Files Library 82, the developer may use the File Manager 56 to move the HTML page into the Included Files Library 82, as detailed hereafter. A file in the Included Files Library 82 may be opened in the HTML Editor by clicking on the file, more preferably by double clicking on the file. Any element in the page of the file may be selected by clicking on the page. A Web-DVD behavior may then be assigned to the element using the Behaviors Window 76 as detailed above regarding assigning behaviors. If a behavior requires an Element ID, then the developer may set the Element ID for the selected element by typing an ID name into the field found in a Current Element Properties tab 88, as shown for example in FIGS. 9 and 10. For example, a Change Image behavior requires that the name of the Element ID for the image that is to be changed be typed in the Element ID field. In order to create an Element ID, open the desired HTML page, click on the image that is to be changed in order to select that image, then type a name in the Element ID field and then click the “Set” icon button.

In another embodiment, an Element ID may already be assigned to the HTML page depending on how the page was created. If a selected HTML page has an assigned Element ID, then the Element ID will appear in the Element ID field in the Current Element Properties tab 88.

The HTML Editor may enable a developer to create and edit new HTML pages for inclusion in the Web-DVD as follows. The HTML Editor preferably includes basic HTML formatting options in tabs and may also include tabs or toolbars with functions including New, Save, Save As, Cut, Copy, Paste, Delete, Undo and Redo. The HTML Editor may also have a toolbar which includes HTML editing tool icons such as enter text, insert image, and draw hotspots.

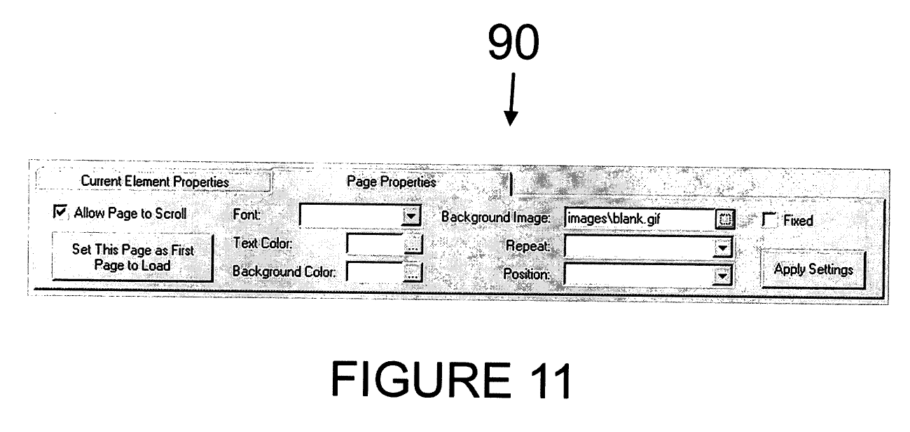

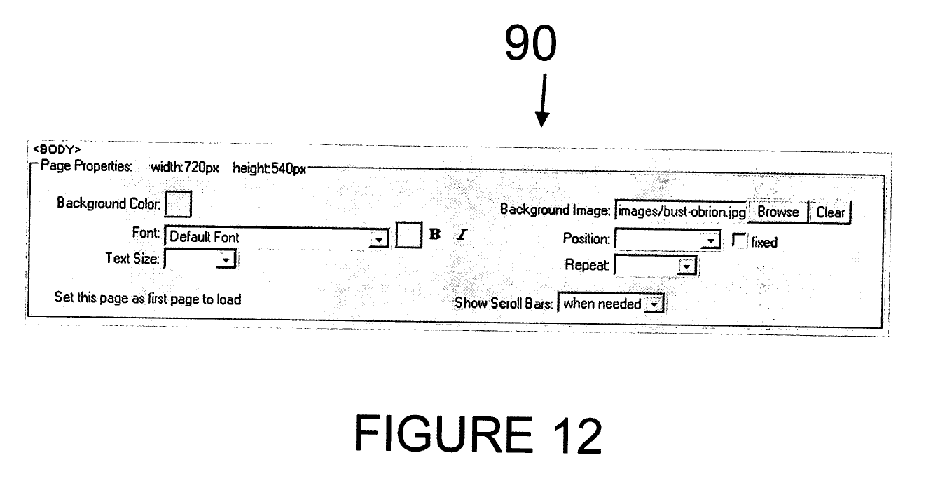

To begin creating a new HTML page, the developer clicks New from the formatting toolbar. Next, the properties of the page may be set using a Page Properties tab 90, as shown for example in FIGS. 11 and 12. The Page Properties tab 90 preferably includes properties which may be set by the developer such as font; text color; background color; background image; repeat; position; allow page to scroll; fixed page; set page as first page to load, and apply settings. Once the desired page properties are selected, the developer clicks the apply settings button for the page properties to take effect.

Text may be entered into a new HTML page by clicking on the text icon button in the toolbar, which inserts a text field into the HTML page. The developer may begin typing, or choose to move and/or resize the text field.

In another embodiment, text may be entered into a new HTML page by clicking on the text icon button in the toolbar. The text field is then drawn on the page and the desired typing is entered. When using the text icon button, the text may be constrained horizontally to the size of the drawn text field. Text may also be entered by clicking a draw hotspots icon button and typing the desired text. When using the draw hotspots icon, the text field can expand horizontally to the length of the text.

When the text is completed, the developer selects Enter and the software application of the invention can insert a break in the text field, resulting in the appearance of double-spaced text. The break enables a developer to assign a behavior to each break if desired. Text can be entered without creating a break by selecting Shift-Enter and single-spacing of the text will result. The spacing of the text may also be accomplished by any other suitable means.

Images may be entered into a new HTML page by clicking an insert image icon button in the toolbar. When the insert image icon button is clicked, a dialogue box appears prompting the developer to select an image from the HTML folder for the Web-DVD project. If the selected image file is not in the HTML folder for the Web-DVD project, the developer will be prompted to copy the image file into the HTML folder. If the image file is not copied into the HTML folder at this point, the software application will copy the image file into the HTML folder when the final ROM image is compiled. The selected image is then inserted into the HTML page by clicking the desired location in the HTML page. The image may appear full-size, but may be resized by dragging on the handles on the corners of the image or in any suitable manner. The image may also be moved by dragging the entire image to a new location.

A developer may assign a Behavior to a hotspot using the Behaviors Window 76 as detailed above. Hotspots may be entered into a new HTML page by clicking on the draw hotspots icon button in the toolbar. Hotspots may be drawn over any part of the page and resized as desired. Hotspots preferably make an area on the Web-DVD a clickable area such as a button or icon.

A developer may arrange the layered order of the elements on the new HTML page by clicking the element and using options such as Bring to Front, Send to Back, Bring Forward, Send Backward from a context menu. When the layout of the HTML page is complete, DVD behaviors may be assigned to any of the elements by using the Behaviors Window in the same manner as detailed above.

The File Manager 56 option on the Web-DVD Application Window 50 enables a developer to move files into the HTML folder in the Included Files Library 82 directory such as, but not limited to, by a drag-and-drop interface without the developer having to leave the application.

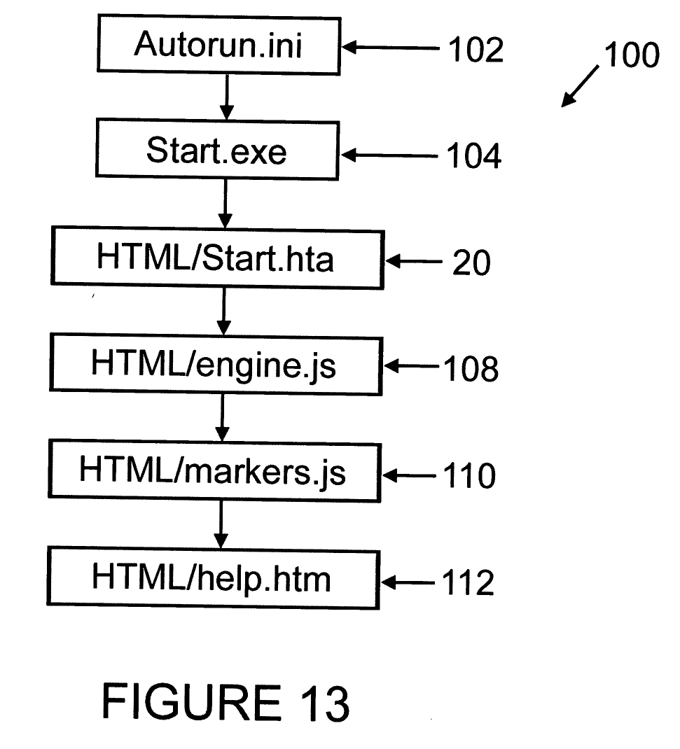

The Preview 58 option on the Web-DVD Application Window 50 will launch the main Web-DVD Application Window 50 and start the created Web-DVD so that the developer may preview the Web-DVD. Preferably, the developer inserts a DVD disk into the disk drive prior to selecting Preview 58 in order to initialize the video object. Upon completion of previewing the Web-DVD project, the Web-DVD application is closed. The software application of the present invention remains open in the background. The developer may press the Play button in the DVD Behaviors Editor to restart the DVD player to view the listings for the Chapters, Markers and Clips and make any changes or modifications. Once the Web-DVD project is complete, the developer clicks the Create ROM Image 66 option on the Web-DVD Application Window 50. The developer will be prompted to select the directory for the final ROM files. By default, the software application of the present invention selects the root directory for the VIDEO_TS folder. Thereafter, the software application preferably writes the following files 100 for the Web-DVD and as shown for example in FIG. 13:

autorun.ini 102

start.exe 104

HTML/start.hta 20

HTML/engine.js 108

HTML/markers.js 110

HTML/help.htm 112

These files contain all of the final ROM files for the Web-DVD that has just been created. Specifically, the autorun.ini file 102 is a file that causes the start.exe file 104 to run automatically upon the insertion of a DVD into a computer. The start.exe file 104 is a binary executable program written and compiled with any suitable programming language. The executable program includes settings that define the size, position and appearance of the Web-DVD Application Window and the file name of the master page (start.hta). Other settings may include, but are not limited to, border width, colors, title bar display and various special effects such as drop shadowing and fade transitions. The executable program can also be set to act as a general springboard should the developer wish to launch an additional application, batch file or a public URL upon insertion of the DVD. The HTML/start.hta file 20 is the master page that is automatically run by the software application when the software application is opened/run on a computer as detailed hereafter. The HTML/engine.js file 108 is the JavaScript library of functions that controls the playback of the DVD-Video content via the computer-based content/HTML content. The behavior array 32 functions with the JavaScript engine 22 to monitor the playback of the DVD-Video content in the video object 24 in order to pass JavaScript commands that control the playback of the DVD-Video content in the video object 24 as well as to pass JavaScript commands that control the computer-based content/HTML content in the I-frame 28. The HTML/markers.js file 110 is an array of the Custom Markers that the developer creates using the DVD Behaviors Editor 70 as detailed above. The HTML/help.htm file 112 is the file that contains documentation about how to operate the completed Web-DVD. When the Web-DVD is ready to be burned, these files are included as ROM content. The Web-DVD may be burned in any suitable manner. The final layout of the Web-DVD will preferably be as follows:

My Disk Name
VIDEO_TS (folder)
autorun.ini
start.exe
HTML (folder).
   However, the Web-DVD may be in any suitable final layout.

The Help 68 option on the Web-DVD Application Window 50 provides instructions and hints to the developer for creating a Web-DVD using the software application of the invention.

The method of the invention detailed above provides bi-directional communication between the DVD-Video content and the computer-based content such that the computer-based content can launch and/or control the playback of the DVD-Video content and the DVD-Video content can launch and/or control the playback of the computer-based content on a Web-DVD. For example, upon completion of making a Web-DVD, the start.exe file 104 launches the master page, e.g., the start.hta 20. The master page houses a suitable software component that can control video playback from the DVD-Video and expose a group of methods and properties to its container, e.g. video object 24, and communicate events to the video object 24, the I-frame control and the library of DVD-control functions called a HTML/engine.js 108. The video object component 24 displays the DVD-Video content. The I-frame effectively acts as a mini-browser to display any HTML content. The JavaScript engine acts as a gateway between the DVD-Video content and the computer-based content, e.g., HTML content. The JavaScript engine controls the DVD-Video content playback while simultaneously allowing the DVD-Video content to control and modify the computer-based content, e.g., HTML content.

With the software application of the invention, the Web-DVD uses the multimedia components built into a computer's operating system so that an end user does not have to install a proprietary player in order to access and view the Web-DVD. The software application utilizes a software component that is able to run inside of a container, such as Visual Basic or a Web Browser, that provides a user interface that can expose a group of methods and properties to its container, communicate events to its container, can be manipulated by a developer and can be distributed in an executable form. For example, a software component that controls the DVD-Video playback is an Active X control that is integrated into the operating system. The ability to read HTML files and JavaScript files is also built into the operating system. Therefore, no additional software needs to be installed on the viewer's computer in order to view the Web-DVD.

Upon viewing a created Web-DVD, the software application automatically runs the master page. For example, when the operating system is Microsoft® Windows®, the software application runs the master page called “start.hta” 20, as shown for example in FIG. 1. This master page 20 has a JavaScript engine 22, a behavior array 32, a video object 24 and an I-frame 28. The JavaScript engine 22 controls the interaction between the DVD-Video content and the other computer-based content. The behavior array 32 functions with the JavaScript engine 22 to monitor the playback of the DVD-video content in the video object 24 in order to pass or transmit JavaScript commands that control the playback of the DVD-video content in the video object 24, as well as to pass or transmit JavaScript commands that control the computer-based content, e.g., HTML content, in the I-frame 28. The video object 24 is embedded in the master page 20 and which enables the DVD-Video content from the VIDEO_TS file 26 to play within the master page 20. The I-frame 28 or inline frame is a floating frame inserted within a Web page which is not bound to a side of a browser window. The I-frame 28 is preferably called a HTML Pane in a preferred embodiment of the invention. In the I-frame, e.g., HTML Pane 28, of the present invention, the developer loads the computer-based content 30, such as HTML content or Web sites, into the Web-DVD project. The content contained in the I-frame/HTML Pane 28 can control the playback of the DVD-Video in the video object 24 and the DVD-Video in the video object 24 can dynamically control the content in the I-frame/HTML Pane 28, thereby providing bi-directional communication between the DVD-Video content and the computer-based/HTML-based content. The computer-based content 30 may also be accessed by opening a new instance of the computer's default Web browser 34. Once opened, the Web browser 34 can access computer-based content such as, but not limited to, HTML content via the Internet, graphics, and PDFs. Preferably Web browsers include, but are not limited to, Internet Explorer®, Netscape® and Safari®. The Web browser 34 may be a separate window from the master page 20.

While the preferred embodiments of the GUI options of the invention have been detailed above, any suitable GUI options and layout and arrangement thereof may be used and fall within the scope of the invention.

Additionally, in another embodiment, a developer may be able to choose the GUI and layout and arrangement thereof that is displayed when the software application of the invention is launched by entering predetermined commands as known in the art. These commands may be entered in conjunction with the JavaScript Engine detailed above. Additionally, in another embodiment, the GUI and layout and arrangement of the software application of the invention may be presented in a plurality of forms, each embodiment of the GUI still providing a graphical user interaction, e.g., “point and click” that enters predetermined commands and creates a series of DVD-ROM files to create a Web-DVD without requiring the developer to be proficient in programming languages such as JavaScript and HTML. These commands, regardless of the layout and arrangement of the GUI, will create a series of DVD-ROM files that is compatible with the system for making a Web-DVD according to the present invention as shown for example in FIG. 1.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A method of making a Web-DVD comprising:
providing a DVD-Video content;
opening a software application which displays a plurality of graphical user interface options;
selecting at least one of said plurality of graphical user interface options from said software application, wherein a predetermined function is associated with said at least one of said plurality of graphical user interface options and at least one computer-based content is provided thereby; and
blending said DVD-Video content and said at least one computer-based content together to form a Web-DVD.

2. The method of making a Web-DVD according to claim 1, further comprising opening a master page, wherein said master page comprises a JavaScript engine, a behavior array, a video object and an I-frame.

3. The method of making a Web-DVD according to claim 2, wherein said JavaScript engine controls interaction between said DVD-Video content and said computer-based content.

4. The method of making a Web-DVD according to claim 2, wherein said behavior array functions with said JavaScript engine to monitor playback of said DVD-Video content which is in said video object to transmit JavaScript commands that control playback of said DVD-Video content in said video object and to transmit JavaScript commands that control said computer-based content which is in said I-frame.

5. The method of making a Web-DVD according to claim 2, wherein said video object is embedded in said master page and enables said DVD-Video content to play within said master page.

6. The method of making a Web-DVD according to claim 2, wherein said I-frame loads said computer-based content into said Web-DVD, wherein said I-frame controls playback of said DVD-Video content in said video object and said DVD-Video content in said video object can control said computer-based content in said I-frame, thereby providing bi-directional communication between said DVD-Video content and said computer-based content.

7. The method of making a Web-DVD according to claim 1, wherein a developer application is opened upon opening said software application, wherein said developer application provides said graphical user interface options thereby allowing a user to create said Web-DVD without typing or writing a computer command language.

8. The method of making a Web-DVD according to claim 7, wherein said developer application is displayed as a Web-DVD Application Window, wherein said software application displays said Web-DVD Application Window as one of said plurality of graphical user interface options.

9. The method of making a Web-DVD according to claim 8, wherein said Web-DVD Application Window includes at least one graphical user interface option including File or File Operations, Project Layout, DVD Behaviors, HTML Behaviors, File Manager, Preview, Create ROM Image and Help.

10. The method of making a Web-DVD according to claim 9, wherein said Project Layout is a Project Layout Editor which is a layout editing page for at least one of a size, layout and/or display attributes for said Web-DVD, wherein said Project Layout Editor comprises a plurality of fields and a windowed area which graphically displays layout choices that are selected from said plurality of fields.

11. The method of making a Web-DVD according to claim 10, wherein said plurality of fields in said Project Layout Editor comprise at least one of: Application Name; Set Video Aspect Ratio; Choose Window Size; Choose Skin; Choose TaskBar Settings; Choose Page Layout; Choose Video Startup State; Choose First Page to Load, and Optional Settings.

12. The method of making a Web-DVD according to claim 9, wherein said DVD Behaviors displays a DVD Behaviors Editor which provides assignment of behaviors to predetermined points in said Web-DVD, thereby creating trigger events which initiate an action when another event occurs, wherein said DVD Behaviors Editor provides creation of predetermined points where behaviors may be assigned in said DVD-Video where no pre-authored chapter points exist.

13. The method of making a Web-DVD according to claim 12, wherein said DVD Behaviors Editor comprises at least one field option including one of a Timeline and Playback Area, a Navigation Library and a Behaviors Window, wherein said Timeline and Playback Area provides navigation of said DVD-Video in order to select appropriate chapter or time points to create said trigger events.

14. The method of making a Web-DVD according to claim 13, wherein said Navigation Library comprises a display and at least one tab including: Chapters, Markers, Clips and Entire DVD tab.

15. The method of making a Web-DVD according to claim 13, wherein said Behaviors Window enables assignment of at least one behavior to at least one of said predetermined points.

16. The method of making a Web-DVD according to claim 9, wherein said HTML Behaviors provides a HTML Behaviors Editor which enables opening of HTML content for inclusion in said Web-DVD.

17. The method of making a Web-DVD according to claim 16, wherein said HTML Behaviors Editor comprises at least one of an Included Files Library, a HTML Editor and a Behaviors Window, wherein said Included Files Library is a directory listing of files and folders located in a HTML folder located in a root directory in a project folder.

18. The method of making a Web-DVD according to claim 17, wherein said HTML Editor provides opening of existing HTML pages and addition of Web-DVD behaviors to said HTML pages, creating and editing new HTML pages for inclusion in said Web-DVD, and a combination thereof.

19. The method of making a Web-DVD according to claim 17, wherein said Behaviors Window enables assignment of at least one behavior to at least one of said predetermined points.

20. The method of making a Web-DVD according to claim 9, wherein said File Manager provides movement of files into a HTML folder in an Included Files Library directory.

21. The method of making a Web-DVD according to claim 1, wherein said software application provides bi-directional communication between said DVD-Video content and said computer-based content such that said computer-based content can launch and/or control playback of said DVD-Video content and said DVD-Video content can launch and/or control playback of said computer-based content on said Web-DVD.

22. The method of making a Web-DVD according to claim 1, wherein said software application enables said Web-DVD to use multimedia components built into an operating system on a computer so that an end user does not have to install a proprietary player in order to access and view said Web-DVD.

23. The method of making a Web-DVD according to claim 1, wherein each of said plurality of graphical user interface options transmits a predetermined command to a computer to obtain said predetermined function.
